(19) United States
(12) Patent Application Publication
(10) Pub. No.: US 2025/0326159 A1
(43) Pub. Date: Oct. 23, 2025

(54) WASTE MIXING DEVICE AND WASTE MIXING PROCESSING EQUIPMENT

(71) Applicants: YEAN HORNG MACHINERY CO., LTD., Tainan City (TW); SAMSARA MATERIALS INC., Vancouver (CA)

(72) Inventor: Shao Heng CHEN, Tainan City (TW)

(21) Appl. No.: 19/176,601

(22) Filed: Apr. 11, 2025

(30) Foreign Application Priority Data
Apr. 17, 2024 (TW) 113114309

(51) Int. Cl. B29B 7/48; B29B 7/58; B29B 7/60; B29B 7/82

(52) U.S. Cl. CPC B29B 7/489; B29B 7/582; B29B 7/60; B29B 7/826

(57) ABSTRACT

Waste mixing processing equipment has a waste mixing device and a feeding device. The waste mixing device has a major mixing set, a sub-mixing set, and an extruding-and-shaping set arranged in sequence. The major mixing device and the sub-mixing device each have a y-shaped mixing passage in a base and tapering toward a discharging port, a driving screw, and a driven screw obliquely disposed therein. Waste and additives/fillers are fed into the major mixing set by proportion, and are mixed sequentially through the major mixing set and the sub-mixing set. The waste and the additives/fillers are mixed, extruded, and conveyed by the driving screw and the driven screw in the y-shaped mixing passages of the major/sub-mixing sets, whereby mixing efficiency is improved.

### BACKGROUND OF THE INVENTION

### 1. Field of the Invention

The present invention relates to mixing equipment for mixing wastes, and more particularly to a waste mixing device and processing equipment designed to improve the efficiency of recycling fiber and plastic wastes.

### 2. Description of Related Art

To address climate change, promote energy conservation, and reduce carbon emissions, transitioning to a circular economy is essential for achieving industrial sustainability. Efficiently recycling and reusing waste materials, such as fibers and plastics, necessitates the use of advanced processing technologies to optimize material recovery.

In the realm of fiber waste recycling, a variety of materials including discarded clothing, old mattresses, and manufacturing byproducts containing cotton or synthetic fibers undergo a breakdown process to isolate individual fibers. These reclaimed fiber wastes are subsequently blended with resins or other additives to create sheet materials or granules. The resulting products can serve as fillers in various applications or be further processed into entirely new items, effectively giving these waste materials a second life in the circular economy.

Plastic waste recycling, particularly for common polymers like polyethylene (PE), polypropylene (PP), PET, polystyrene (PS), and PVC, faces distinct technical hurdles. Materials ranging from packaging and industrial plastics to consumer products require systematic conversion into standardized material streams before additives can be incorporated for reuse. A critical challenge arises during pre-processing: shredded plastic waste often develops a porous, aerated structure that impedes homogeneous mixing with binding agents. This issue is especially pronounced with PE plastics, where shredded flakes retain a low-density, lightweight and airy structure that resists uniform integration with other materials, complicating the creation of consistent recycled products.

Standard industrial mixing systems typically employ single or twin-screw extruders with helical screw mechanisms to process materials under heat. While effective for basic applications, these conventional approaches face critical operational constraints.

A primary limitation lies in their inconsistent blending performance caused by the significant different mechanical properties of fiber, multiple plastic waste streams and of materials added for the intended compound: Fiber residues like cotton or synthetics tend to exhibit low-density, voluminous structures during initial processing phases, resisting even dispersion within the mixture. Similarly, plastic fragments—particularly shredded PE and PP polymers—frequently form lightweight agglomerations with irregular morphology. These aerated clusters prove exceptionally resistant to combining evenly with functional additives such as silica, calcium phosphate, ceramic particulates, tile powder, talc, or reinforcing glass fibers, which are significantly heavier than flakes and fibers, preventing material uniformity in recycled outputs.

Conventional twin-screw mixers face inherent design limitations due to their synchronized rotational speeds. This fixed-speed operation creates a fundamental compromise—high rotational velocities induce material extrusion that disrupts blending uniformity, while slower speeds sacrifice processing throughput. The challenge intensifies with polymer particulates like PE and PS, where electrostatic charges on fragment surfaces repel additive materials such as mineral fillers or reinforcing agents.

Furthermore, thermal management shortcomings pose critical risks: uneven heat distribution during processing can trigger premature polymer degradation in area closer to the screws, resulting in compromised material properties and inconsistent product quality.

To address these challenges, an improved waste mixing device and processing equipment are required to ensure uniform mixing, mitigate electrostatic interference, achieve precise additive integration, and enhance material processing efficiency.

### SUMMARY OF THE INVENTION

The main objective of the present invention is to provide a waste mixing device and waste mixing processing equipment to improve efficiency of mixing waste with additives/fillers.

The waste mixing device comprises a major mixing set, a sub-mixing set, and an extruding-and-shaping set sequentially arranged along a mixing path. The major mixing set comprises a pre-mixing unit, a heating-and-conveying unit, and a mixing unit sequentially arranged along the mixing path. The mixing unit is arranged next to the heating-and-conveying unit and is driven with the pre-mixing unit. The sub-mixing set comprises a pre-mixing unit arranged next to the mixing unit and a heating-and-conveying unit sequentially arranged along the mixing path. The extruding-and-shaping set is arranged next to the heating-and-conveying unit of the sub-mixing set. Each of the pre-mixing units comprises a base, a driving screw, a driven screw, and a driving unit. The base comprises a mixing passage formed in the base, a discharging port fluidly communicating with one of two ends of the mixing passage along the mixing path and arranged at a side of the base, and a feeding port fluidly communicating with the other end of the mixing passage and arranged at a top of the base. The mixing passage gradually tapers from the feeding port toward the discharging port. The driving screw is rotatably and straightly arranged in the mixing passage of the base and comprises a driving helical section and an attached section at one of two ends of the driving helical section. The driving helical section extends through the discharging port of the base. The attached section of the driving screw extends out of the base. The driven screw is rotatably and obliquely arranged in the mixing passage of the base and comprises a driven helical section and a connection section at one of two ends of the driven helical section. The other one of the two ends of the driven helical section is adjacent to the discharging port and the driving helical section of the driving screw. The connection section of the driven screw deviates away from the attached section of the driving screw. The driven helical section helically corresponds to the driving helical section of the driving screw in shape. The driving unit is disposed outside the base and is connected to the attached section of the driving screw and the connection section of the driven screw. The driving unit drives the driving screw and the driven screw to rotate. Each of the heating-and-conveying units is arranged next to the discharging port of the base of a corresponding one of the pre-mixing units and comprises a transmission tube being thermally conductive and at least one heating unit disposed at an outer side of the transmission tube. The transmission tube fluidly communicates with the discharging port of the base of the corresponding pre-mixing unit. The driving helical section of the driving screw of the corresponding pre-mixing unit extends into the transmission tube of the heating-and-conveying unit.

The waste mixing device in accordance with the present invention comprises the major mixing set, the sub-mixing set, and the extruding-and-shaping set arranged in sequence to provide two mixing stages. Each pre-mixing unit, either the pre-mixing unit of the major mixing set or the sub-mixing set, has the driving screw and the driven screw in the mixing passage. The driven screw is arranged obliquely in the mixing passage and relative to the driving screw. A distance between the driving screw and driven screw along the mixing path gradually decreases. Meanwhile, the mixing passage tapers from the feeding port along the mixing path to be y-shaped. Accordingly, when the driving screw is driven to rotate forwardly, the driven screw is driven to rotate reversely relative to the driving screw. With the arrangement of the oblique driven screw and the driving screw in the y-shaped mixing passage, the waste with the additives/fillers in the y-shaped mixing passage may be subjected to a helical pressing force gradually increased. As the result, the waste with the additives/fillers is efficiently mixed by the helical pressing force gradually increased and quickly conveyed. The waste with the additives/fillers can be quickly mixed through the major mixing set and the sub-mixing set, thereby enhancing mixing efficiency.

In addition, the major mixing set and the sub-mixing set may be set to operate at different mixing speeds or the same mixing speed according to the properties of the waste. The major mixing set may be set to operate at a high mixing speed to primarily mix the waste with the additives/fillers. The waste with puffy fibers or plastics may be mixed with the additives or fillers at a proper speed to reduce damages to the fibers or plastics in the waste. After that, the waste is mixed via the sub-mixing set at a low speed to improve the uniformity of the mix of the waste. The mixtures of the waste with the additives/fillers can be stably conveyed to the extruding-and-shaping set and reproduced to sheet or granular waste mixtures by the extruding-and-shaping set. Therefore, the waste with puffy fibers or plastics can be uniformly and efficiently mixed with the additives or fillers and conveyed along the mixing path. With the high speed and the low speed provided by the two mixing stages and with the arrangement of the pre-mixing units of the major mixing set and the sub-mixing set, a gradually increased pressing force helically applied to the waste with the additives/fillers in the y-shaped mixing passages. In the major mixing set, the waste with the additives/fillers can be re-mixed by the mixing unit arranged next to the at least one heating unit of the pre-mixing unit, thereby enhancing the mixing effect.

The waste mixing process equipment comprises a waste mixing device and a feeding device. The waste mixing device comprises a major mixing set, a sub-mixing set, and an extruding-and-shaping set sequentially arranged along a mixing path. The feeding device comprises a waste conveyor configured to convey waste and a minor conveyor configured to convey additives or fillers. The major mixing set comprises a pre-mixing unit, a heating-and-conveying unit, and a mixing unit sequentially arranged along the mixing path. The mixing unit is arranged next to the heating-and-conveying unit and is driven with the pre-mixing unit. The sub-mixing set comprises a pre-mixing unit arranged next to the mixing unit and a heating-and-conveying unit sequentially arranged along the mixing path. The extruding-and-shaping set is arranged next to the heating-and-conveying unit of the sub-mixing set. Each of the pre-mixing units comprises a base, a driving screw, a driven screw, and a driving unit. The base comprises a mixing passage formed in the base, a discharging port fluidly communicating with one of two ends of the mixing passage along the mixing path and arranged at a side of the base, and a feeding port fluidly communicating with the other end of the mixing passage and arranged at a top of the base. The mixing passage gradually tapers from the feeding port toward the discharging port. The driving screw is rotatably and straightly arranged in the mixing passage of the base and comprises a driving helical section and an attached section at one of two ends of the driving helical section. The driving helical section extends through the discharging port of the base. The attached section of the driving screw extends out of the base. The driven screw is rotatably and obliquely arranged in the mixing passage of the base and comprises a driven helical section and a connection section at one of two ends of the driven helical section. The other one of the two ends of the driven helical section is adjacent to the discharging port and the driving helical section of the driving screw. The connection section of the driven screw deviates away from the attached section of the driving screw. The driven helical section helically corresponds to the driving helical section of the driving screw in shape. The driving unit is arranged outside the base and is connected to the attached section of the driving screw and the connection section of the driven screw and is configured to drive the driving screw and the driven screw to rotate. Each of the heating-and-conveying units is arranged next to the discharging port of the base of a corresponding one of the pre-mixing units and comprises a transmission tube being thermally conductive and at least one heating unit disposed at an outer side of the transmission tube. The transmission tube fluidly communicates with the discharging port of the base of the corresponding pre-mixing unit. The driving helical section of the driving screw of the corresponding pre-mixing unit extends into the transmission tube of the heating-and-conveying unit. The waste conveyor comprises a first feeder, a tank, and a belt conveyor. The first feeder extends to the feeding port of the base of the pre-mixing unit of the major mixing set. The tank is arranged outside the first feeder and is configured to contain the waste. The belt conveyor is arranged between the tank and the first feeder. The waste in the tank is conveyed to the first feeder via the belt conveyor and is conveyed into the major mixing set via the first feeder. The minor conveyor comprises a second feeder. The second feeder extends to the feeding port of the base of the major mixing set and is configured to convey the additives or fillers to the major mixing set.

The waste and the additives/fillers may be fed into the major mixing set at a constant volume per unit time by the waste conveyor and the minor conveyor, respectively, thereby controlling the mixing radio of the waste and the additives/fillers. The waste and the additives/fillers are mixed via the waste mixing device to achieve a good waste mixing effect.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of an embodiment of a waste mixing device in accordance with the present invention;

FIG. 2 is a top view of the waste mixing device in FIG. 1;

FIG. 3 is an enlarged perspective view of a major mixing set of the waste mixing device in FIG. 1;

FIG. 4 is a partially exploded perspective view of the major mixing set in FIG. 3;

FIG. 5 is an enlarged perspective view of a sub-mixing set and an extruding-and-shaping set in FIG. 1;

FIG. 6 is a partially exploded perspective view of the sub-mixing set in FIG. 5;

FIG. 7 is a perspective view of an embodiment of waste mixing processing equipment in accordance with the present invention;

FIG. 8 is another perspective view of the waste mixing processing equipment in FIG. 7;

FIG. 9 is an enlarged perspective view of the waste mixing processing equipment in FIG. 8; and

FIG. 10 is a top view of the waste mixing processing equipment in FIGS. 7 and 8.

### DETAILED DESCRIPTION OF THE PREFERRED EMBODIMENT

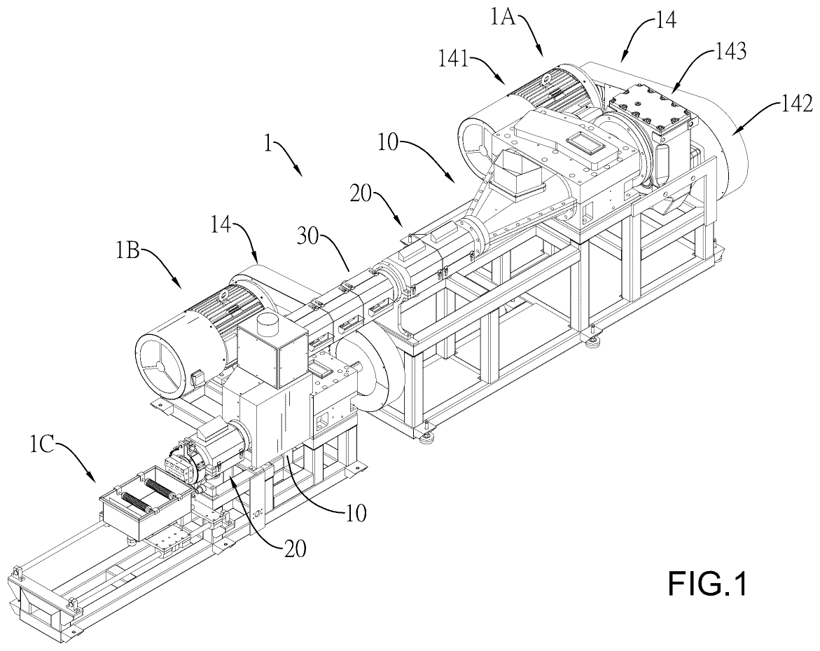

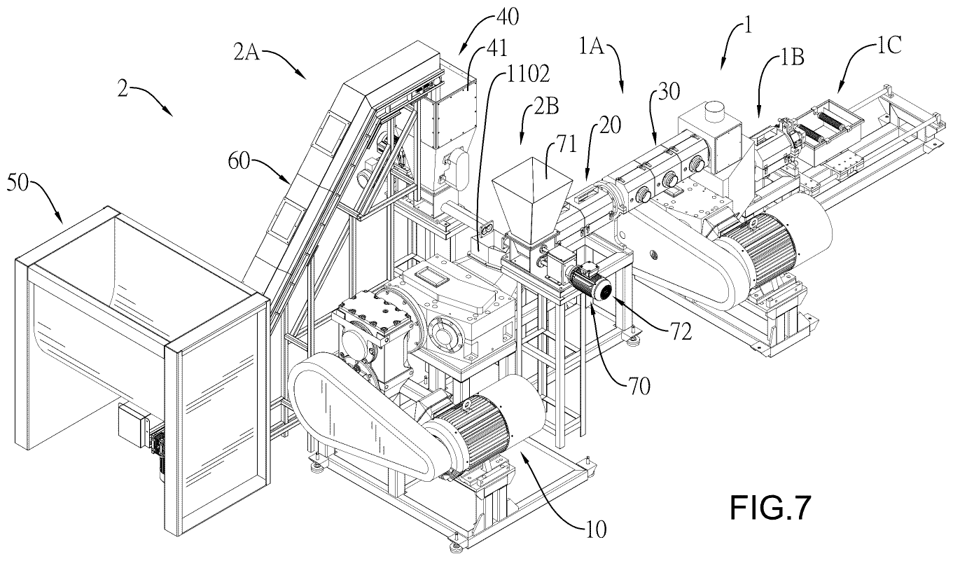

As shown in FIGS. 1 and 7, a waste mixing device 1 and waste mixing processing equipment in accordance with the present invention are disclosed. The waste mixing processing equipment comprises the waste mixing device 1.

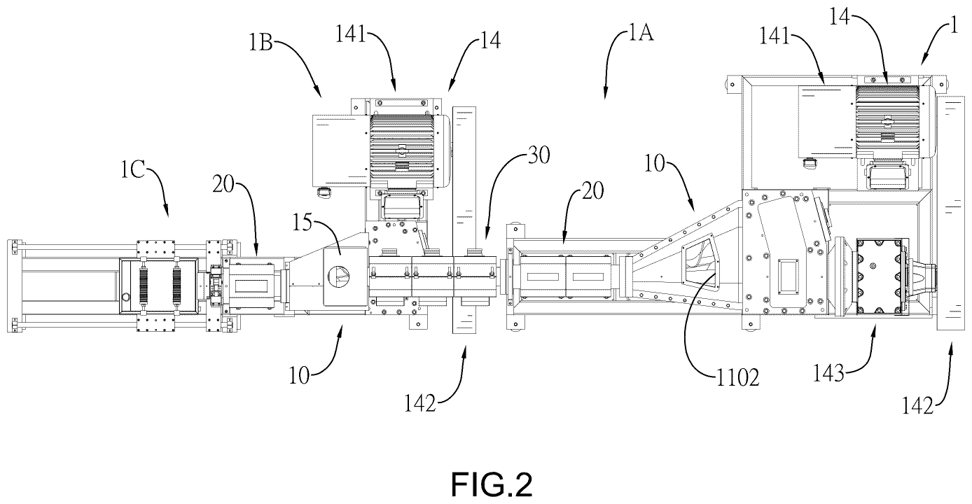

With reference to FIGS. 1 and 2, an embodiment of the waste mixing device 1 comprises a major mixing set 1A, a sub-mixing set 1B, and an extruding-and-shaping set 1C sequentially arranged along a mixing path.

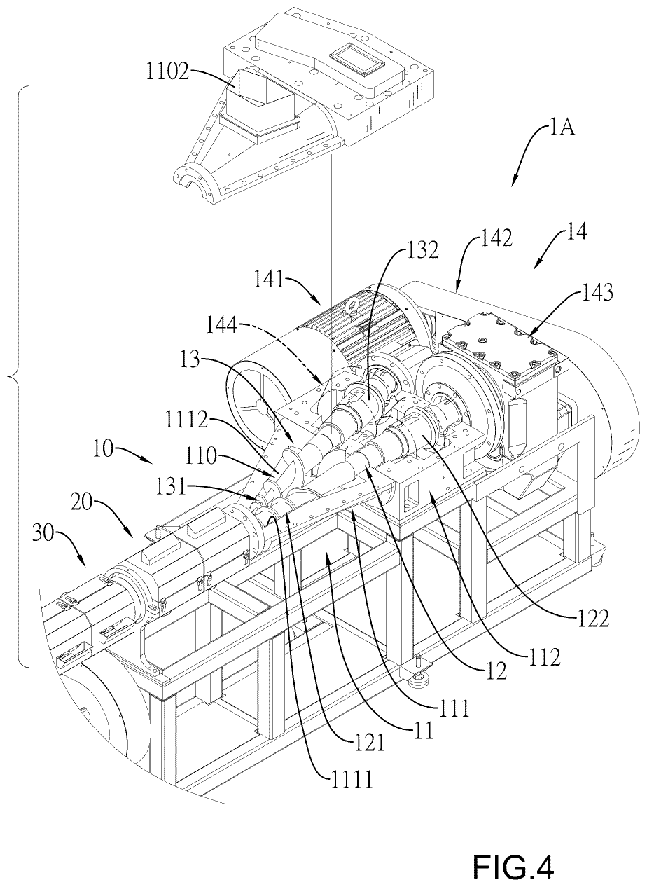

With reference to FIGS. 1 to 4, the major mixing set 1A comprises a pre-mixing unit 10, a heating-and-conveying unit 20, and a mixing unit 30 sequentially arranged along the mixing path. With reference to FIGS. 1, 2, 5, and 6, the sub-mixing set 1B comprises a pre-mixing unit 10 and a heating-and-conveying unit 20 arranged along the mixing path. The pre-mixing units 10 and the heating-and-conveying units 20 of the major mixing set 1A and the sub-mixing set 1B comprise substantially the same structures.

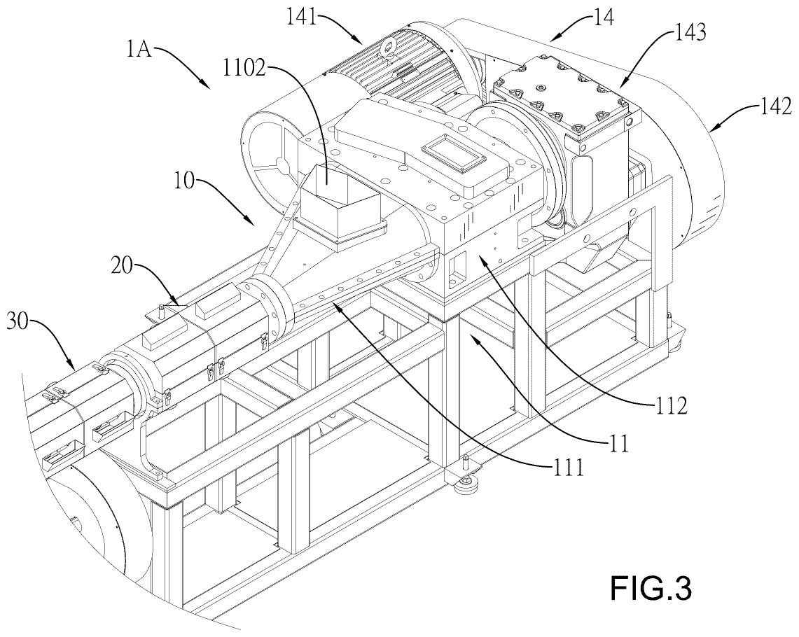

With reference to FIGS. 3 to 6, the pre-mixing unit 10 comprises a base 11, a driving screw 12, a driven screw 13, and a driving unit 14. The base 11 has a mixing passage 110 formed therein. A discharging port fluidly communicates with an end of the mixing passage 110 along the mixing path and is arranged at a side of the base 11. A feeding port fluidly communicates with another end of the mixing passage 110 and is arranged at a top of the base 11. In the embodiment, a hopper 1102 is mounted on the top of the base 11 around the feeding port. The mixing passage 110 tapers from the feeding port along the mixing path to form a space substantially being “y-shaped”. The mixing passage 110 has a cross-sectional area gradually decreasing from the feeding port toward the discharging port.

With reference to FIGS. 3 to 6, in the embodiment, the base 11 comprises a base body 111 and a lateral portion 112. The mixing passage 110 is formed in the base body 111. The discharging port of the mixing passage 110 is at a side the base body 111. An assembling side is defined at another side of the base body 111. The feeding port is located at a top of the base body 111 with the hopper 1102 mounted therearound. In the embodiment, the mixing passage 110 in the base body 111 is a one-side inclined space. The two opposite ends of the mixing passage 110 along the mixing path have unequal sizes, wherein the end of the mixing passage 110 adjacent to the feeding port is larger than the end thereof adjacent to the discharging port. The base body 111 has a straight side wall 1111 and an inclined side wall 1112 respectively disposed at opposite sides of the mixing passage 110. The straight side wall 1111 is parallel to a central axis of the discharging port.

With reference to FIGS. 3 to 6, the driving screw 12 is rotatably and straightly arranged in the mixing passage 110 of the base 11. The driving screw 12 comprises a driving helical section 121 and an attached section 122 at an end of the driving helical section 121. A helical blade helically surrounds the driving helical section 121. The driving helical section 121 of the driving screw 12 extends through the discharging port in the base 11. The attached section 122 of the driving screw 12 extends out of the base 11. In the embodiment, the driving helical section 121 is adjacent to and is parallel to the straight side wall 1111 of the mixing passage 110. The attached section 122 is rotatably disposed in and extends out of the lateral portion 112.

With reference to FIGS. 3 to 6, the driven screw 13 is rotatably and obliquely arranged in the mixing passage 110 of the base 11. An oblique angle is formed between a central axis of the driven screw 13 and a central axis of the driving screw 12. The driven screw 13 has a driven helical section 131 and a connection section 132 at an end of the driven helical section 131. A helical blade helically surrounds the driven helical section 131. An end of the driven helical section 131 away from the connection section 132 is adjacent to the discharging portion and the driving helical section 121 of the driving screw 12. The connection section 132 deviates from the attached section 122 of the driving screw 12. The helical blade of the driven helical section 131 and the helical blade of the driving helical section 121 are helically engaged with each other. In the embodiment, the driven helical section 131 is adjacent to and parallel to the inclined side wall 1112 of the mixing passage 110. The connection section 132 of the driven screw 13 is rotatably disposed in the lateral portion 112. That is, a distance between the ends of the driven helical section 131 and the driving helical section 121 away from the connection section 132 and the attached section 122 is smaller than a distance between the ends of the driven helical section 131 and the driving helical section 121 adjacent to the connection section 132 and the attached section 122. The helical blade around the end of the driven helical section 131 away from the connection section 132 corresponds to the helical blade on the driving helical section 121 of the driving screw 12 helically.

With reference to FIGS. 3 to 6, the driving unit 14 is disposed on the base 11 and is connected to the attached section 122 of the driving screw 12 and the connection section 132 of the driven screw 13 and is configured to drive the driving screw 12 and the driven screw 13 to spin. Waste and additives/fillers fed into the mixing passage 110 of the base 11 are helically mixed, extruded, and gradually transmitted toward the discharging port by the driving screw 12 cooperating with the oblique driven screw 13.

Mixing speeds of the major mixing set 1A and the sub-mixing set 1B may be set according to material properties of the waste for mixing. Wherein the mixing motion may be set as a variable velocity motion or a constant velocity motion. Preferably, the mixing speed in the major mixing set 1A is faster than that in the sub-mixing set 1B.

With reference FIGS. 3 to 6, in the embodiment, the major mixing set 1A and the sub-mixing set 1B may proceed with the variable velocity motions and provide proper driving powers for mixing. In the pre-mixing unit 10 of the major mixing set 1A, the driving unit 14 comprises a motor 141, a flexible transmitting set 142, a reducer 143, and a bevel gear set 144. The flexible transmitting set 142 is disposed between and is connected with the motor 141 and the reducer 143. The attached section 122 of the driving screw 12 is connected to the reducer 143. The attached section 122 of the driving screw 12 is connected to the connection section 132 of the driven screw 13 via the bevel gear set 144. Therefore, when the driving screw 12 is driven to rotate forwardly, the driven screw 13 is driven to rotate reversely relative to the driving screw 12 at an equal speed. The driving unit 14 of the pre-mixing unit 10 of the major mixing set 1A can drive the driving screw 12 and the driven screw 13 to rotate at a low speed with high torque via the transmission of the motor 141 and the reducer 143.

In the pre-mixing unit 10 of the sub-mixing set 1B, the driving set 14 comprises a motor 14, a flexible transmitting set 142, and a bevel gear set 144. The flexible transmitting set 142 is disposed between and connects the motor 141 and the attached section 122 of the driving screw 12. The attached section 122 of the driving screw 12 is connected to the connection section 132 of the driven screw 13 via the bevel gear set 144 to drive the driven screw 13 to rotate with the driving screw 12.

With reference to FIGS. 3 to 6, the heating-and-conveying unit 20 is disposed adjacent to the discharging port of the base 11 and comprises a transmission tube and at least one heating unit at an outer side of the transmission tube. The transmission tube is a thermally conductive tube. An inlet port and an outlet port are respectively arranged at two ends of the transmission tube. The heating unit is an object to provide heat energy, e.g. an electrical heating unit. The driving helical section 121 of the driving screw 12 extends into the transmission tube to helically convey the waste in the transmission tube. The waste is kept at a pre-set working temperature in the transmission tube by the heating unit. An amount of said heating unit is based on actual usage requirements. In the embodiment, the heating-and-conveying unit 20 of the major mixing set 1A comprises two heating units arranged in succession. The heating-and-conveying unit 20 of the sub-mixing set 1B comprises one sole heating unit. The amount of said heating unit is not limited.

With reference to FIGS. 1 to 4, the mixing unit 30 of the major mixing set 1A is arranged at an outlet end of the heating-and-conveying unit 20 of the major mixing set 1A and is followed by the feeding port of the base 11 of the pre-mixing unit 10 of the sub-mixing set 1B. The mixing unit 30 may be a planetary mixing unit which is conventional. The mixing unit 30 substantially comprises a mixing tube, a major mixing screw, and multiple planet mixing screws. The mixing tube has multiple internal helical teeth arranged around an internal peripheral surface thereof at equiangular intervals. The major mixing screw and the multiple planet mixing screws are connected with each other and are disposed in the mixing tube. The major mixing screw is connected to and is driven with the driving screw 12. The multiple planet mixing screws are helically connected between the internal helical teeth of the mixing tube and the major mixing screw. The major mixing screw and the driving screw 12 are driven to rotate. The multiple planet mixing screws are indirectly driven to revolve around the major mixing screw and each rotate axially between the major mixing screw and the mixing tube. Whereby, the waste can be finely mixed between the mixing tube and the major mixing screw. Preferably, the mixing unit 30 comprises at least one heater disposed at an outer peripheral of the mixing tube. The heater may be an electrical heater which is configured to keep the waste in the mixing tube at a pre-set working temperature for the mixing process.

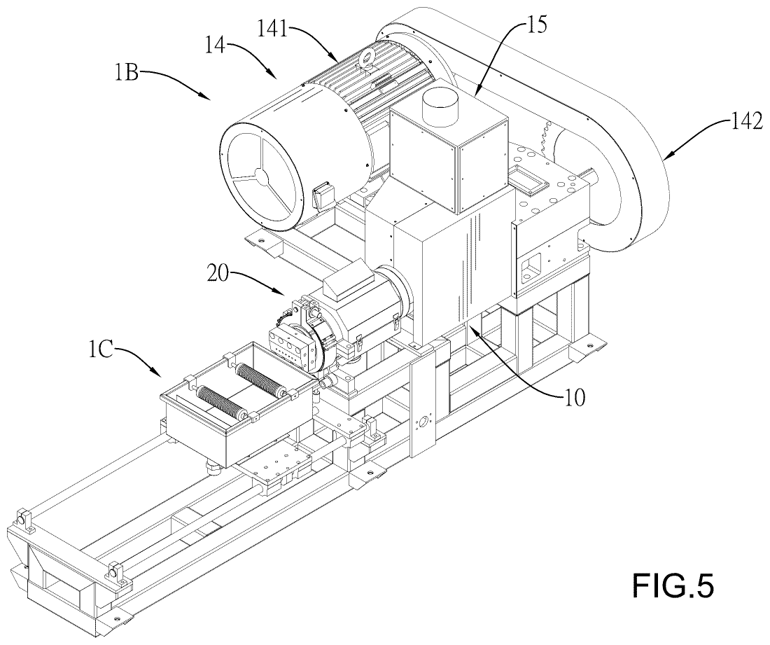

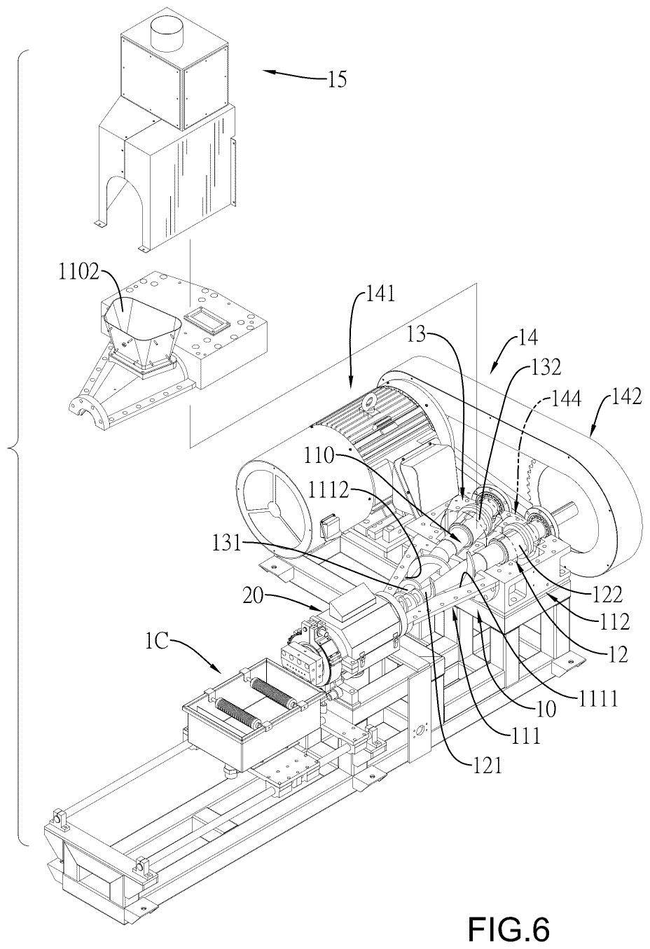

The mixing tube of the mixing unit 30 of the major mixing set 1A is connected to and fluidly communicates with the transmission tube of the heating-and-conveying unit 20. The major mixing screw is connected to an end segment of the driving helical section 121 of the driving screw 12 and is driven to rotate with the driving screw 12. An outlet port of the mixing unit 30 is at an end of the mixing tube away from the heating-and-conveying unit 20. The feeding port of the base 11 of the pre-mixing unit 10 of the sub-mixing set 1B is next to the outlet port of the mixing unit 30 of the major mixing set 1A. The hopper 1102 around the feeding port of the base 11 of the sub-mixing set 1B is arranged below the outlet port of the mixing unit 30 of the major mixing set 1A. As shown in FIGS. 5 and 6, in the pre-mixing unit 10 of the sub-mixing set 1B, a guiding hood 15 is mounted outside the base 11 and fluidly communicates with the hopper 1102 around the feeding port. The guiding hood 15 is arranged below the output port of the mixing unit 30 of the major mixing set 1A.

With reference to FIGS. 1, 2, 5, and 6, the extruding-and-shaping set 1C has a feeding portion and an exporting portion respectively at opposite two ends thereof. The feeding portion is next to the outlet port of the sub-mixing set 1B. The extruding-and-shaping set 1C may be a conventional extruder, a conventional sheet preforming machine, or a conventional granulator. Details thereof are omitted. In the embodiment, the end of the transmission tube of the heating-and-conveying unit 20 of the sub-mixing set 1B is the outlet port and is followed by the feeding portion of the extruding-and-shaping set 1C.

With reference to FIGS. 1, 2, 3, and 6, when the waste mixing device 1 in accordance with the present invention is in use, the waste and additives/fillers are fed into the feeding port of the major mixing set 1A, are mixed via the major mixing set 1A and the sub-mixing set 1B by two mixing stages, and are reproduced into multiple sheet or granular waste mixtures in predetermined sizes via the extruding-and-shaping set 1C.

The major mixing set 1A and the sub-mixing set 1B each have the pre-mixing unit 10 with arrangement of the driving screw 12 and the oblique driven screw 13 in the mixing passage 110 of the base 11. A distance between the driving screw 12 and the driven screw 13 gradually decreases along the mixing path. The mixing passage 110 tapers from the feeding port along the mixing path and is y-shaped. When the driving screw 12 and the driven screw 13 are driven to spin, with the structural relationship of the y-shaped mixing passage 110 and the driven screw 13 oblique relative to the driving screw 12, the waste with the additives/fillers in the y-shaped mixing passage 110 may be subjected to a helical pressing force gradually increased. The waste and the additives/fillers are well and efficiently mixed and conveyed along the mixing path. The waste with the additives/fillers in the mixing passage 110 is helically mixed, compressed, and conveyed progressively. The major mixing set 1A and the sub-mixing set 1B can provide the two mixing stages to achieve a good mixing effect.

The major mixing set 1A and the sub-mixing set 1B may be set to operate at different mixing speeds or at the same mixing speed according to the properties of the waste. Preferably, in the embodiment, the mixing speeds of the major mixing set 1A and the sub-mixing set 1B are different. Wherein, the waste and the additives/fillers are primarily mixed via the major mixing set 1A at a high mixing speed, so the waste with puffy fibers or plastics may be gathered and primarily mixed with the additives/fillers at a proper speed, and damages to said fibers or plastics in the waste are reduced. After that, the waste is mixed via the sub-mixing set 1B at a low speed to improve the uniformity of the mix of the waste. The mixtures of the waste with the additives/fillers are stably conveyed to the extruding-and-shaping set 1C and are reproduced to sheet or granular waste mixtures by the extruding-and-shaping set 1C. Therefore, the waste is mixed through a high mixing speed stage and a low mixing speed stage and is progressively and helically mixed, extruded, and conveyed in the pre-mixing units 10 of the major mixing set 1A and the sub-mixing set 1B. In addition, the major mixing set 1A further comprises the mixing unit 30 arranged behind the pre-mixing unit 10 thereof for finely mixing the waste to achieve a good waste mixing effect.

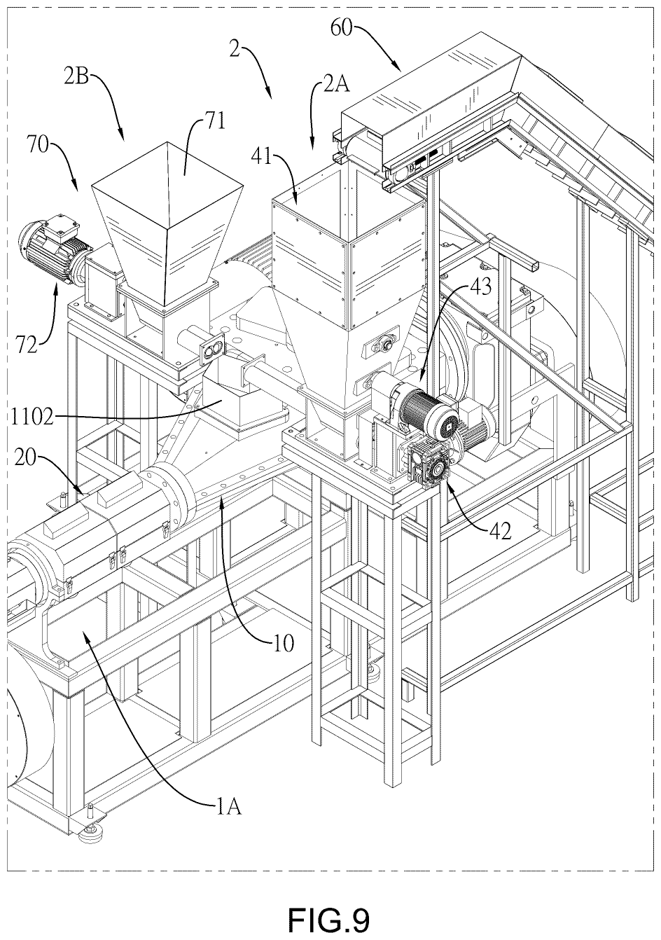

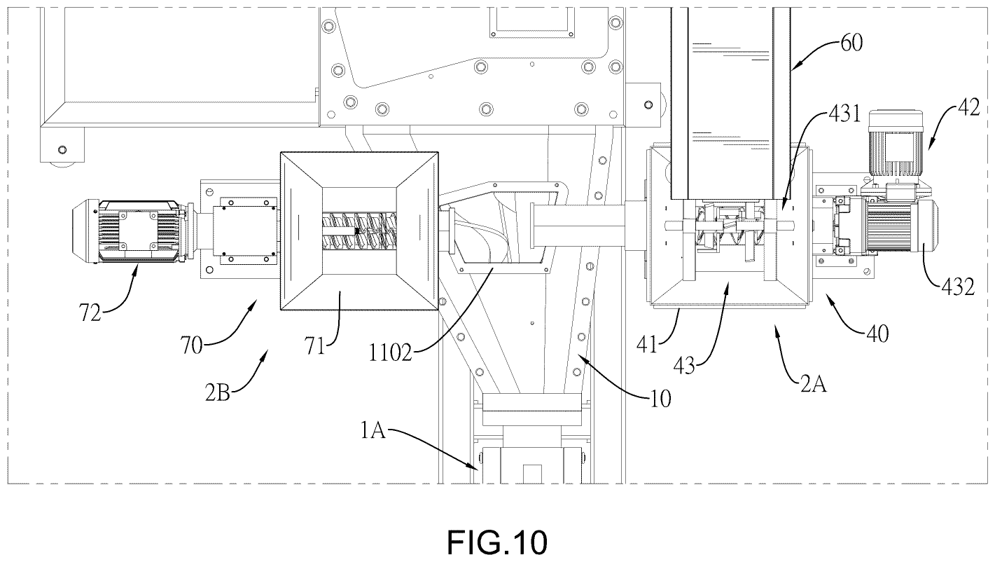

With reference to FIGS. 7 to 10, an embodiment of the waste mixing processing equipment in accordance with the present invention comprises a waste mixing device 1 and a feeding device 2. Details of the structures, driving actions, and functions of the waste mixing device 1 are illustrated as foregoing and are omitted.

With reference to FIGS. 7 to 10, the feeding device 2 comprises a waste conveyor 2A and a minor conveyor 2B. The waste conveyor 2A comprises a first feeder 40, a tank 50, and a belt conveyor 60. The first feeder 40 extends to the feeding port of the base 11 of the major mixing set 1A. The tank 50 is arranged outside the first feeder 40 and is configured to contain waste. The belt conveyor 60 is arranged between the tank 50 and the first feeder 40. The waste in the tank 50 is conveyed to the first feeder 40 via the belt conveyor 60 and is conveyed into the major mixing set 1A via the first feeder 40 at a constant volume per unit time. The minor conveyor 2B comprises a second feeder 70 extending to the feeding port of the base 11 of the major mixing set 1A. The additives/fillers are conveyed to the major mixing set 1A via the second feeder 70 at a constant volume per unit time. Whereby, mixing ratio of the waste and the additives/fillers can be controlled.

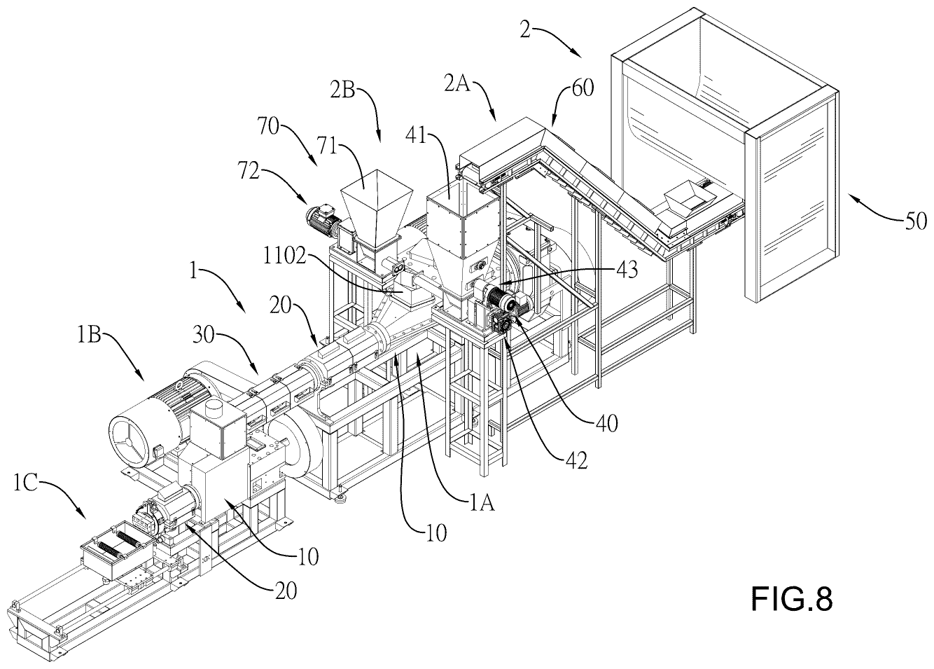

With reference to FIGS. 7 and 8, in the embodiment, the waste conveyor 2A further comprises a stirring set configured to stir the waste in the tank 50. The stirring set may be conventional, and details thereof are omitted.

With reference to FIGS. 7 to 10, in the embodiment, the first feeder 40 comprises a first hopper 41 and a first transmitting set 42 arranged below the first hopper 41. The second feeder 70 comprises a second hopper 71 and a second transmitting set 72 arranged below the second hopper 71. The first feeder 40 and the second feeder 70 are respectively arranged at opposite sides of the hopper 1102 around the feeding port of the major mixing set 1A. The waste is fed into the feeding port of the major mixing set 1A via the first feeder 40, and the additives/fillers are fed into the feeding port of the major mixing set 1A via the second feeder 70. The first/second transmitting set 42/72 may be an electrical twin-screw conveyor, which is conventional, and details thereof are omitted.

With reference FIGS. 7 to 10, the first feeder 40 comprises a propelling set 43 disposed at a lower segment of the first hopper 41 and configured to provide a propelling force to the waste in the first hopper 41. The propelling set 43 comprises a stirring rod 431 rotatably disposed in the lower segment of the first hopper 41 and a motor set 432 disposed outside the first hopper 41 and connected to the stirring rod 431. The stirring rod 431 is driven by the motor set 432 to propel the waste and to break bridging effect of the waste in the first hopper 41. The waste is facilitated to move down into the first transmitting set 42, and then is convoyed into the major mixing set 1A by the first transmitting set 42.

With reference FIGS. 7 to 10, when the waste mixing processing equipment in accordance with the present invention is in use, the waste is fed into the feeding port of the major mixing set 1A via the waste conveyor 2A, and the additives/fillers are fed into the feeding port of the major mixing set 1A via the minor conveyor 2B. The waste and the additives/fillers are mixed in two mixing stages through the waste mixing device 1, and then are extruded to form sheet or granular waste mixtures in predetermined size via the extruding-and-shaping set 1C. The waste and the additives/fillers may be fed into the major mixing set 1A at a constant volume per unit time by the waste conveyor 2A and the minor conveyor 2B, respectively, thereby controlling the mixing radio of the waste and the additives/fillers. The waste and the additives/fillers are mixed through the waste mixing device 1 to achieve a good waste mixing effect.

What is claimed is:

1. A waste mixing device comprising a major mixing set, a sub-mixing set, and an extruding-and-shaping set sequentially arranged along a mixing path;
the major mixing set comprising a pre-mixing unit, a heating-and-conveying unit, and a mixing unit sequentially arranged along the mixing path, the mixing unit arranged next to the heating-and-conveying unit and driven with the pre-mixing unit;
the sub-mixing set comprising a pre-mixing unit arranged next to the mixing unit of the major mixing set and a heating-and-conveying unit sequentially arranged along the mixing path;
the extruding-and-shaping set arranged next to the heating-and-conveying unit of the sub-mixing set; wherein
each of the pre-mixing units comprises:
a base comprising a mixing passage formed in the base, a discharging port fluidly communicating with one of two ends of the mixing passage along the mixing path and arranged at a side of the base, and a feeding port fluidly communicating with the other end of the mixing passage and arranged at a top of the base;
the mixing passage gradually tapering from the feeding port toward the discharging port;
a driving screw rotatably and straightly arranged in the mixing passage of the base and comprising a driving helical section and an attached section at one of two ends of the driving helical section; the driving helical section extending through the discharging port of the base; and the attached section of the driving screw extending out of the base;
a driven screw rotatably and obliquely arranged in the mixing passage of the base and comprising a driven helical section and a connection section at one of two ends of the driven helical section; the other one of the two ends of the driven helical section adjacent to the discharging port and the driving helical section of the driving screw; the connection section of the driven screw deviating away from the attached section of the driving screw; and the driven helical section helically corresponding to the driving helical section of the driving screw in shape; and
a driving unit arranged outside the base and connected to the attached section of the driving screw and the connection section of the driven screw and configured to drive the driving screw and the driven screw to rotate;
each of the heating-and-conveying units is arranged next to the discharging port of the base of a corresponding one of the pre-mixing units and comprises a transmission tube being thermally conductive and at least one heating unit disposed at an outer side of the transmission tube;
the transmission tube fluidly communicating with the discharging port of the base of the corresponding pre-mixing unit; and
the driving helical section of the driving screw of the corresponding pre-mixing unit extending into the transmission tube of the heating-and-conveying unit.

2. The waste mixing device as claimed in claim 1, wherein
the base of each of the pre-mixing units comprises a base body and a lateral portion;
the mixing passage of each of the pre-mixing units is formed in the base body of the base of the pre-mixing unit;
the discharging port of each of the pre-mixing units is arranged at a side of the base body of the base of the pre-mixing unit;
the feeding port of each of the pre-mixing units is arranged at a top of the base body of the base of the pre-mixing unit with a hopper;
the lateral portion of the base of each of the pre-mixing units is arranged at another side of the base body of the base of the pre-mixing unit;
the mixing passage in the base body of the base of each of the pre-mixing units is a one-side inclined space and has a straight side wall and an inclined side wall, the straight side wall being parallel to a central axis of the discharging port of the base;
the driving helical section of the driving screw of each of the pre-mixing units is adjacent to and is parallel to the straight side wall of the mixing passage of the pre-mixing unit, and the attached section of the driving screw is rotatably disposed in and extends out of the lateral portion of the base of the pre-mixing unit;
the driven helical section of the driven screw of each of the pre-mixing units is adjacent to and is parallel to the inclined side wall of the mixing passage of the pre-mixing unit, and the connection section of the driven screw is rotatably disposed in the lateral portion of the base of the pre-mixing unit; and
the hopper around the feeding port of the base of the sub-mixing set is arranged below an outlet port of the mixing unit of the major mixing set.

3. The waste mixing device as claimed in claim 2, wherein
the driving unit of the pre-mixing unit of the major mixing set comprises a motor, a flexible transmitting set, a reducer, and a bevel gear set;
the flexible transmitting set is connected between the motor and the reducer;
the reducer is connected to the attached section of the driving screw of the pre-mixing unit of the major mixing set;
the attached section of the driving screw is connected to the connection section of the driven screw of the pre-mixing unit of the major mixing set via the bevel gear set;
the driving unit of the pre-mixing unit of the sub-mixing set comprises a motor, a flexible transmitting set connected to the motor and the attached section of the driving screw of the pre-mixing unit of the sub-mixing set, and a bevel gear set connected between the attached section of the driving screw and the connection section of the driven screw of the pre-mixing unit of the sub-mixing set.

4. The waste mixing device as claimed in claim 1, wherein the mixing unit is a planetary mixing unit and is driven with the driving screw of the pre-mixing unit of the major mixing set.

5. The waste mixing device as claimed in claim 2, wherein the mixing unit is a planetary mixing unit and is driven with the driving screw of the pre-mixing unit of the major mixing set.

6. The waste mixing device as claimed in claim 3, wherein the mixing unit is a planetary mixing unit and is driven with the driving screw of the pre-mixing unit of the major mixing set.

7. Waste mixing process equipment comprising:
a waste mixing device comprising a major mixing set, a sub-mixing set, and an extruding-and-shaping set sequentially arranged along a mixing path; and
a feeding device comprising a waste conveyor configured to convey waste and a minor conveyor configured to convey additives or fillers; wherein
the major mixing set comprises a pre-mixing unit, a heating-and-conveying unit, and a mixing unit sequentially arranged along the mixing path;
the mixing unit is arranged next to the heating-and-conveying unit and is driven with the pre-mixing unit;
the sub-mixing set comprises a pre-mixing unit arranged next to the mixing unit of the major mixing set and a heating-and-conveying unit sequentially arranged along the mixing path;
the extruding-and-shaping set is arranged next to the heating-and-conveying unit of the sub-mixing set; wherein
each of the pre-mixing units comprises:
a base comprising a mixing passage formed in the base, a discharging port fluidly communicating with one of two ends of the mixing passage along the mixing path and arranged at a side of the base, and a feeding port fluidly communicating with the other end of the mixing passage and arranged at a top of the base;
the mixing passage gradually tapering from the feeding port toward the discharging port;
a driving screw rotatably and straightly arranged in the mixing passage of the base and comprising a driving helical section and an attached section at one of two ends of the driving helical section; the driving helical section extending through the discharging port of the base; and the attached section of the driving screw extending out of the base;
a driven screw rotatably and obliquely arranged in the mixing passage of the base and comprising a driven helical section and a connection section at one of two ends of the driven helical section; the other one of the two ends of the driven helical section adjacent to the discharging port and the driving helical section of the driving screw; the connection section of the driven screw deviating away from the attached section of the driving screw; and the driven helical section helically corresponding to the driving helical section of the driving screw in shape; and
a driving unit arranged outside the base and connected to the attached section of the driving screw and the connection section of the driven screw and configured to drive the driving screw and the driven screw to rotate;
each of the heating-and-conveying units is arranged next to the discharging port of the base of a corresponding one of the pre-mixing units and comprises a transmission tube being thermally conductive and at least one heating unit disposed at an outer side of the transmission tube;
the transmission tube fluidly communicates with the discharging port of the base of the corresponding pre-mixing unit; and
the driving helical section of the driving screw of the corresponding pre-mixing unit extends into the transmission tube of the heating-and-conveying unit;
the waste conveyor comprises a first feeder, a tank, and a belt conveyor;
the first feeder extends to the feeding port of the base of the pre-mixing unit of the major mixing set;
the tank is arranged outside the first feeder and is configured to contain the waste;
the belt conveyor is arranged between the tank and the first feeder;
the waste in the tank is conveyed to the first feeder via the belt conveyor and is conveyed into the major mixing set via the first feeder;
the minor conveyor comprises a second feeder;
the second feeder extends to the feeding port of the base of the major mixing set and is configured to convey the additives or the fillers to the major mixing set.

8. The waste mixing process equipment as claimed in claim 7, wherein
the base of each of the pre-mixing units comprises a base body and a lateral portion;
the mixing passage of each of the pre-mixing units is formed in the base body of the base of the pre-mixing unit;
the discharging port of each of the pre-mixing units is arranged at a side of the base body of the base of the pre-mixing unit;
the feeding port of each of the pre-mixing units is arranged at a top of the base body of the base of the pre-mixing unit with a hopper;
the lateral portion of the base of each of the pre-mixing units is arranged at another side of the base body of the base of the pre-mixing unit;
the mixing passage in the base body of the base of each of the pre-mixing units is a one-side inclined space and has a straight side wall and an inclined side wall, the straight side wall being parallel to a central axis of the discharging port of the base;
the driving helical section of the driving screw of each of the pre-mixing units is adjacent to and is parallel to the straight side wall of the mixing passage of the pre-mixing unit, and the attached section of the driving screw is rotatably disposed in and extends out of the lateral portion of the base of the pre-mixing unit;
the driven helical section of the driven screw of each of the pre-mixing units is adjacent to and is parallel to the inclined side wall of the mixing passage of the pre-mixing unit, and the connection section of the driven screw is rotatably disposed in the lateral portion of the base of the pre-mixing unit; and
the hopper around the feeding port of the base of the sub-mixing set is arranged below an outlet port of the mixing unit of the major mixing set.

9. The waste mixing processing equipment as claimed in claim 8, wherein
the driving unit of the pre-mixing unit of the major mixing set comprises a motor, a flexible transmitting set, a reducer, and a bevel gear set;
the flexible transmitting set is connected between the motor and the reducer;
the reducer is connected to the attached section of the driving screw of the pre-mixing unit of the major mixing set;
the attached section of the driving screw is connected to the connection section of the driven screw of the pre-mixing unit of the major mixing set via the bevel gear set;
the driving unit of the pre-mixing unit of the sub-mixing set comprises a motor, a flexible transmitting set connected to the motor and the attached section of the driving screw of the pre-mixing unit of the sub-mixing set, and a bevel gear set connected between the attached section of the driving screw and the connection section of the driven screw of the pre-mixing unit of the sub-mixing set.

10. The waste mixing processing equipment as claimed in claim 7, wherein the mixing unit is a planetary mixing unit and is driven with the driving screw of the pre-mixing unit of the major mixing set.

11. The waste mixing processing equipment as claimed in claim 8, wherein the mixing unit is a planetary mixing unit and is driven with the driving screw of the pre-mixing unit of the major mixing set.

12. The waste mixing processing equipment as claimed in claim 9, wherein the mixing unit is a planetary mixing unit and is driven with the driving screw of the pre-mixing unit of the major mixing set.

13. The waste mixing processing equipment as claimed in claim 7, wherein
the first feeder comprises a first hopper and a first transmitting set below the first hopper;
the second feeder comprises a second hopper and a second transmitting set below the second hopper;
the first feeder and the second feeder are respectively arranged at opposite sides of the hopper around the feeding port of the base of the pre-mixing unit of the major mixing set;
the waste is fed into the feeding port of the base of the pre-mixing unit of the major mixing set via the first feeder; and
the additives or the fillers are fed into the feeding port of the base of the pre-mixing unit of the major mixing set via the second feeder.

14. The waste mixing processing equipment as claimed in claim 8, wherein
the first feeder comprises a first hopper and a first transmitting set below the first hopper;
the second feeder comprises a second hopper and a second transmitting set below the second hopper;
the first feeder and the second feeder are respectively arranged at opposite sides of the hopper around the feeding port of the base of the pre-mixing unit of the major mixing set;
the waste is fed into the feeding port of the base of the pre-mixing unit of the major mixing set via the first feeder; and
the additives or the fillers are fed into the feeding port of the base of the pre-mixing unit of the major mixing set via the second feeder.

15. The waste mixing processing equipment as claimed in claim 9, wherein
the first feeder comprises a first hopper and a first transmitting set below the first hopper;
the second feeder comprises a second hopper and a second transmitting set below the second hopper;
the first feeder and the second feeder are respectively arranged at opposite sides of the hopper around the feeding port of the base of the pre-mixing unit of the major mixing set;
the waste is fed into the feeding port of the base of the pre-mixing unit of the major mixing set via the first feeder; and
the additives or the fillers are fed into the feeding port of the base of the pre-mixing unit of the major mixing set via the second feeder.

16. The waste mixing processing equipment as claimed in claim 10, wherein
the first feeder comprises a first hopper and a first transmitting set below the first hopper;
the second feeder comprises a second hopper and a second transmitting set below the second hopper;
the first feeder and the second feeder are respectively arranged at opposite sides of the hopper around the feeding port of the base of the pre-mixing unit of the major mixing set;
the waste is fed into the feeding port of the base of the pre-mixing unit of the major mixing set via the first feeder; and
the additives or the fillers are fed into the feeding port of the base of the pre-mixing unit of the major mixing set via the second feeder.

17. The waste mixing processing equipment as claimed in claim 11, wherein
the first feeder comprises a first hopper and a first transmitting set below the first hopper;
the second feeder comprises a second hopper and a second transmitting set below the second hopper;
the first feeder and the second feeder are respectively arranged at opposite sides of the hopper around the feeding port of the base of the pre-mixing unit of the major mixing set;
the waste is fed into the feeding port of the base of the pre-mixing unit of the major mixing set via the first feeder; and
the additives or the fillers are fed into the feeding port of the base of the pre-mixing unit of the major mixing set via the second feeder.

18. The waste mixing processing equipment as claimed in claim 12, wherein
the first feeder comprises a first hopper and a first transmitting set arranged below the first hopper;
the second feeder comprises a second hopper and a second transmitting set below the second hopper;
the first feeder and the second feeder are respectively arranged at opposite sides of the hopper around the feeding port of the base of the pre-mixing unit of the major mixing set;
the waste is fed into the feeding port of the base of the pre-mixing unit of the major mixing set via the first feeder; and
the additives or the fillers are fed into the feeding port of the base of the pre-mixing unit of the major mixing set via the second feeder.

19. The waste mixing processing equipment as claimed in claim 13, wherein
the first feeder comprises a propelling set disposed at a lower segment of the first hopper;
the propelling set comprises a stirring rod rotatably disposed in the lower segment of the first hopper and a motor set disposed outside the first hopper and connected to the stirring rod.

20. The waste mixing processing equipment as claimed in claim 14, wherein
the first feeder comprises a propelling set disposed at a lower segment of the first hopper;
the propelling set comprises a stirring rod rotatably disposed in the lower segment of the first hopper and a motor set disposed outside the first hopper and connected to the stirring rod.
